(19) United States
(12) Patent Application Publication
(10) Pub. No.: US 2014/0085065 A1
(43) Pub. Date: Mar. 27, 2014

(54) ELECTROACTIVE POLYMER ACTUATOR FEEDBACK APPARATUS SYSTEM AND METHOD

(71) Applicants: Silmon James Biggs, Los Gatos, CA (US); Roger N. Hitchcock, San Leandro, CA (US)

(72) Inventors: Silmon James Biggs, Los Gatos, CA (US); Roger N. Hitchcock, San Leandro, CA (US)

(73) Assignee: Bayer Intellectual Property GmbH, Monheim (DE)

(21) Appl. No.: 14/003,093

(22) PCT Filed: Mar. 9, 2012
(86) PCT No.: PCT/US2012/028402

§ 371 Date: Oct. 17, 2013

Related U.S. Application Data
(60) Provisional application No. 61/450,772, filed on Mar. 9, 2011.
(60) Provisional application No. 61/472,777, filed on Apr. 7, 2011.

(51) Int. Cl. G06F 3/01; G08B 6/00

(52) U.S. Cl. CPC G06F 3/016; G08B 6/00
USPC 340/407.2

(57) ABSTRACT

An electronic damping feedback control system for an electroactive polymer module, an electroactive polymer device, and a computer-implemented method for creating realistic effects are provided. The electronic damping controller is coupled in a feedback loop between a user interface device and an electroactive polymer actuator, where the actuator is coupled to the user interface device. The electronic damping controller is configured to receive an actuation signal from the user interface device in response to a user input. In response to the actuation signal, the electronic damping controller generates an electronic damping signal to couple to the actuator. The electroactive polymer device includes a user interface device, an electroactive polymer actuator coupled to the user interface device, and the electronic damping controller. The present invention may provide improved user interface devices.

### CROSS REFERENCE TO RELATED APPLICATION

This application claims the benefit, under 35 USC §119(e), of U.S. provisional patent application Nos. 61/450,772, filed Mar. 9, 2011, entitled “ELECTROACTIVE POLYMER HAPTIC ACTUATOR UTILIZING ELECTRONIC DAMPING FOR IMPROVED KEY CLICK REPLICATION ON TOUCHSCREEN”; and 61/472,777, filed Apr. 7, 2011, entitled “METHOD OF CREATING REALISTIC HAPTIC EFFECTS”; the entire disclosure of each of which is hereby incorporated by reference.

### FIELD OF THE INVENTION

In various embodiments, the present disclosure relates generally to user interface devices, and more specifically to the utilization of electronic damping for improved “key click” replication on devices commonly used for interfacing with computers and mechanical devices by a user. The present disclosure also relates to a method of creating realistic tactile response when a user touches a surface, presses a button or key, or turns a knob.

### BACKGROUND OF THE INVENTION

Users interface with electronic and mechanical devices on a daily basis in a variety of applications. Such applications include interacting with touchscreen displays on smartphones and tablet computers, computer mice, trackballs, touch pad devices, remote control devices, user interfaces for appliances, gaming controllers and consoles, computer displays. Some interface devices provide force feedback or tactile feedback to the user, referred collectively as “haptic feedback.” Haptic versions of touchscreen displays, mice, joysticks, steering wheels, touch pads, game controllers, among other types of devices, already provide the user with some form of haptic feedback. Some hand held mobile devices and gaming controllers, for example, employ conventional haptic feedback devices using small vibrators to enhance the user's gaming experience by providing force feedback vibration to the user while playing video games or to acknowledge that a virtual button has been selected on a touchscreen display.

Although such vibrators may be adequate for providing tactile feedback by delivering a sensation to the user, they do not adequately replicate the actual “key click” sensation. Furthermore, when conventional electroactive polymer feedback devices are used to move a touchscreen to provide tactile feedback, they produce mechanical ringing that cause undesirable sensations. Often, such undesirable sensations are manifested as an inherent “buzziness” when attempting to provide a “key click” response sensation to the user. This produces an unrealistic feeling to the user.

Creating realistic effects using non-linear systems has proven to be challenging. Conventional techniques, for example, use a trial and error approach with graphical interfaces. Such techniques, however, do not provide the designer with the required waveforms and require a “guess and try” approach to providing realistic haptic effects.

To overcome these and other challenges experienced with conventional haptic feedback devices, the present disclosure provides electroactive polymer based feedback modules implemented on dielectric elastomers that have the bandwidth and the energy density required to make user interface devices that are both responsive and compact. Such electroactive polymer feedback modules include a thin sheet, which comprises a dielectric elastomer film sandwiched between two electrode layers. When a high voltage is applied to the electrodes, the two attracting electrodes compress the portion of the sheet sandwiched between the electrode layers. The electroactive polymer feedback device may have the form of a slim, low-powered module that can be placed underneath a touchscreen display to provide haptic feedback. Such feedback devices provide improved electroactive polymer actuators that create realistic “key click” sensations and responses using electronic damping techniques and a click reproduction technique.

### SUMMARY OF THE INVENTION

The present disclosure applies to various aspects of an electroactive polymer based actuator. In one embodiment, an electronic damping feedback control system for an electroactive polymer module is provided. The system comprises an electronic damping controller coupled in a feedback loop between a user interface device and an electroactive polymer actuator, wherein the electroactive polymer actuator is coupled to the user interface device. The electronic damping controller is configured to receive an actuation signal from the user interface device in response to a user input. In response to the actuation signal, the electronic damping controller is to generate an electronic damping signal to drive the actuator and dampen mechanical vibrations. The present invention may provide improved user interface devices such as, for example, touchscreen displays, tablet computers, laptop computers, computer mice, trackballs, touch pad devices, remote control devices, user interfaces for appliances, gaming controllers, gaming consoles, portable gaming systems, computer displays, hand held devices, smartphones, mobile devices, mobile phones, mobile Internet devices, personal digital assistants, global positioning system receivers, remote controls, computer and gaming peripherals, and the like.

### FIGURES

FIG. 1 is a cutaway view of an electroactive polymer system, according to one embodiment;

FIG. 2A illustrates a top perspective view of a transducer portion of an electroactive polymer system in accordance with one embodiment, according to one embodiment;

FIG. 2B illustrates a top perspective view of the transducer portion of the electroactive polymer system shown in FIG. 2A including deflection in response to a change in electric field, according to one embodiment;

FIG. 3A is a diagram of a system for quantifying the performance of an electroactive polymer module that provides suitable capability for gaming/music and click applications, according to one embodiment;

FIG. 3B is a functional block diagram of the system shown in FIG. 2A, according to one embodiment;

FIG. 4A is a mechanical system model of the actuator mechanical system shown in FIGS. 3A-B, according to one embodiment;

FIG. 4B illustrates a performance model of an electroactive polymer actuator, according to one embodiment;

FIG. 5A illustrates one aspect of a segmented actuator configured in a bar array geometry, according to one embodiment;

FIG. 5B is a side view of the segmented actuator shown in FIG. 5A that illustrates one aspect of an electrical arrangement of the phases with respect to the frame and bars elements of the actuator, according to one embodiment;

FIG. 5C is a side view illustrating the mechanical coupling of the frame to a backplane and the bars to an output plate, according to one embodiment;

FIG. 6A is a graphical representation of predicted click amplitude that a candidate module could provide in service for the palm and fingertip, according to one embodiment;

FIG. 6B is a graphical representation of predicted click sensation that a candidate module could provide in service for the palm and fingertip, according to one embodiment;

FIG. 7 is a graphical representation of steady state response of the module with a test mass was measured on the bench top, modeled (line) versus measured (points), according to one embodiment;

FIG. 8 is a graphical representation of observed click data for two users (points), and predictions of the model for an average user (lines), according to one embodiment;

FIG. 9A illustrates an electronic damping system comprising a segmented actuator coupled to a user interface device and an electronic damping controller, according to one embodiment;

FIG. 9B is a graphical representation of a damping voltage control signal generated by the electronic damping controller in response to an actuation signal, according to one embodiment;

FIG. 9C is a graphical representation of a displacement curve representative of the motion of an electroactive polymer actuator in response to a damping voltage control signal, according to one embodiment;

FIG. 9D illustrates an electronic damping controller, according to one embodiment;

FIG. 10 is a logic diagram of a computer-implemented method 1000 of creating realistic effects;

FIG. 11 illustrates a system in which embodiments of the method described in connection with FIG. 10 can be implemented, according to one embodiment; and

FIG. 12 illustrates an example environment that is representative of the general purpose computer for implementing various aspects of the computer-implemented method for quantifying the capability of an electroactive polymer apparatus, according to one embodiment.

### DETAILED DESCRIPTION OF THE INVENTION

Before explaining the embodiments of electroactive polymer feedback devices, it should be noted that the disclosed embodiments are not limited in application or use to the details of construction and arrangement of parts illustrated in the accompanying drawings and description. The disclosed embodiments may be implemented or incorporated in other embodiments, variations and modifications, and may be practiced or carried out in various ways. Further, unless otherwise indicated, the terms and expressions employed herein have been chosen for the purpose of describing the embodiments for illustrative purposes and for the convenience of the reader and are not intended for the purposes of limiting any of the embodiments to the particular ones disclosed. Further, it should be understood that any one or more of the disclosed embodiments, expressions of embodiments, and examples can be combined with any one or more of the other disclosed embodiments, expressions of embodiments, and examples, without limitation. Thus, the combination of an element disclosed in one embodiment and an element disclosed in another embodiment is considered to be within the scope of the present disclosure and appended claims.

The present invention provides an electronic damping feedback control system for an electroactive polymer module, the system comprising an electronic damping controller coupled in a feedback loop between a user interface device and an electroactive polymer actuator, wherein the actuator is coupled to the user interface device, and wherein the electronic damping controller is configured to receive an actuation signal from the user interface device in response to a user input and, in response to the actuation signal, the electronic damping controller is to generate an electronic damping signal to drive the actuator and dampen mechanical movement.

In various embodiments, the present disclosure provides electroactive polymer feedback devices that provide realistic “key click” sensations and responses using electronic damping techniques and a click reproduction technique. It will be appreciated that the terms “electroactive polymer” and “dielectric elastomer” may be used interchangeably throughout the present disclosure. These and other specific embodiments are illustrated and described hereinbelow.

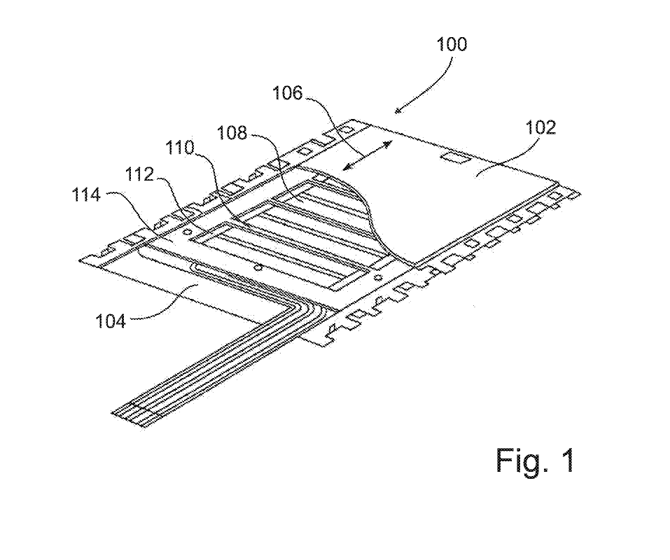

The present disclosure provides various embodiments of electroactive polymer integrated feedback devices. Before launching into a description of various integrated devices comprising electroactive polymer based feedback modules, the present disclosure briefly turns to FIG. 1, which illustrates a cutaway view of an electroactive polymer system, according to one embodiment, that may be integrally incorporated with various devices, such as, for example, touchscreen displays, tablet computers, laptop computers, computer mice, trackballs, touch pad devices, remote control devices, user interfaces for appliances, gaming controllers, gaming consoles, portable gaming systems, computer displays, hand held devices, smartphones, mobile devices, mobile phones, mobile Internet devices, personal digital assistants, global positioning system receivers, remote controls, computer and gaming peripherals, and the like. The integrated electroactive polymer system enhances the user's tactile feedback experience. One embodiment of an electroactive polymer system is now described with reference to the electroactive polymer module 100. An electroactive polymer actuator slides an output plate 102 (e.g., sliding surface) relative to a fixed plate 104 (e.g., fixed surface) when energized by a high voltage. The plates 102, 104 are separated by steel balls and have features that constrain movement to the desired direction, limit travel, and withstand drop tests. For integration into a mobile device, the top plate 102 may be attached to an inertial mass such as the battery or the touch surface, screen, or display of the mobile device. In the embodiment illustrated in FIG. 1, the top plate 102 of the electroactive polymer module 100 is comprised of a sliding surface that mounts to an inertial mass or back of a touch surface that can move bi-directionally as indicated by arrow 106. Between the output plate 102 and the fixed plate 104, the electroactive polymer module 100 comprises at least one electrode 108, optionally at least one divider 110, and at least one bar 112 that attach to the sliding surface, e.g., the top plate 102. Frame and divider segments 114 attach to a fixed surface, e.g., the bottom plate 104. The electroactive polymer module 100 may comprise any number of bars 112 configured into arrays to amplify the motion of the sliding surface. The electroactive polymer module 100 may be coupled to the drive electronics of an actuator controller circuit via a flex cable.

Advantages of the electroactive polymer module 100 include providing force feedback responses to the user that are more realistic sensations, can be felt substantially immediately, consume significantly less battery life, and are suited for customizable design and performance options. The electroactive polymer module 100 is representative of electroactive polymer modules developed by Artificial Muscle, Inc. (AMI), of Sunnyvale, Calif.

Still with reference to FIG. 1, many of the design variables of the electroactive polymer module 100, (e.g., thickness, footprint) may be fixed by the needs of module integrators while other variables (e.g., number of dielectric layers, operating voltage) may be constrained by cost. Because actuator geometry—the allocation of footprint to rigid supporting structure versus active dielectric—does not impact cost much, it is a reasonable way to tailor performance of the electroactive polymer module 100 to an application where the electroactive polymer module 100 is integrated with a mobile device.

Computer implemented modeling techniques can be employed to gauge the merits of different actuator geometries, such as: (1) Mechanics of the Handset/User System; (2) Actuator Performance; and (3) User Sensation. Together, these three components provide a computer-implemented process for estimating the haptic capability of candidate designs and using the estimated haptic capability data to select a haptic design suitable for mass production. The model predicts the capability for two kinds of effects: long effects (gaming and music), and short effects (key clicks). “Capability” is defined herein as the maximum sensation a module can produce in service. Such computer-implemented processes for estimating the haptic capability of candidate designs are described in more detail in commonly assigned International PCT Patent Application No. PCT/US2011/000289, filed Feb. 15, 2011, entitled “HAPTIC APPARATUS AND TECHNIQUES FOR QUANTIFYING CAPABILITY THEREOF,” the entire disclosure of which is hereby incorporated by reference.

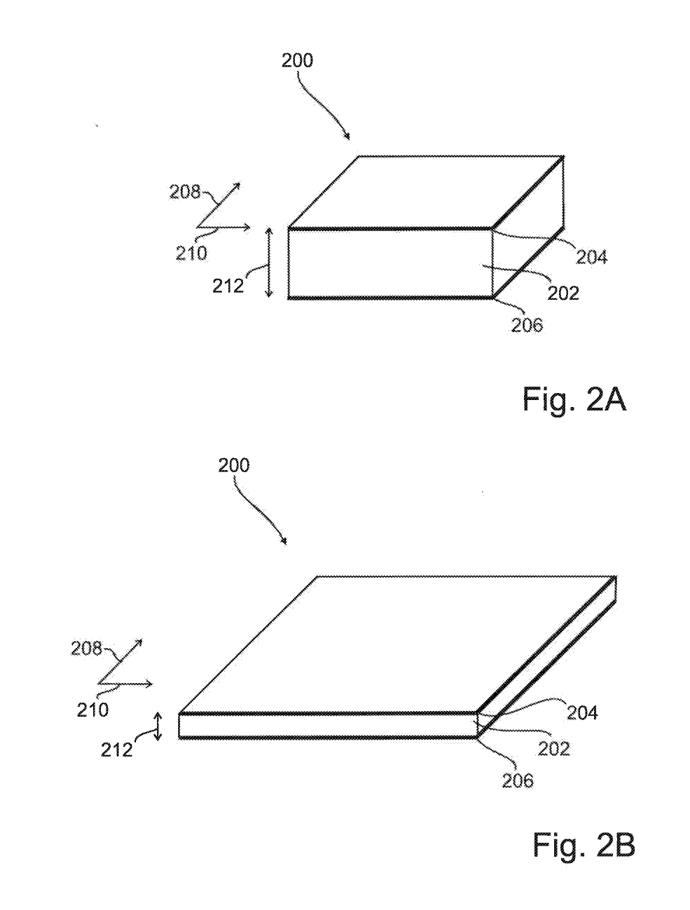

The transformation between electrical and mechanical energy in devices of the present disclosure is based on energy conversion of one or more active areas of an electroactive polymer, such as for example, a dielectric elastomer. Electroactive polymers deflect when actuated by electrical energy. To help illustrate the performance of an electroactive polymer in converting electrical energy to mechanical energy, FIG. 2A illustrates a top perspective view of a transducer portion 200, according to one embodiment. The transducer portion 200 comprises an electroactive polymer 202 for converting between electrical energy and mechanical energy. In one embodiment, an electroactive polymer refers to a polymer that acts as an insulating dielectric between two electrodes and may deflect upon application of a voltage difference between the two electrodes. Top and bottom electrodes 204 and 206 are attached to the electroactive polymer 202 on its top and bottom surfaces, respectively, to provide a voltage difference across a portion of the polymer 202. The polymer 202 deflects with a change in electric field provided by the top and bottom electrodes 204 and 206. Deflection of the transducer portion 200 in response to a change in electric field provided by the electrodes 204 and 206 is referred to as actuation. As the polymer 202 changes in shape, thickness and/or area, the deflection may be used to produce mechanical work.

FIG. 2B illustrates a top perspective view of the transducer portion 200 including deflection in response to a change in electric field, according to one embodiment. In general, deflection refers to any displacement, expansion, contraction, torsion, linear or area strain, or any other deformation of a portion of the polymer 202. The change in electric field corresponding to the voltage difference applied to or by the electrodes 204, 206 produces mechanical pressure within the polymer 202. In this case, the unlike electrical charges produced by the electrodes 204, 206 attract each other and provide a compressive force between the electrodes 204, 206 and an expansion force on the polymer 202 in the planar directions 208, 210, causing the polymer 202 to compress between the electrodes 204, 206 and stretch in the planar directions 208, 210.

In some cases, the electrodes 204, 206 cover a limited portion of the polymer 202 relative to the total area of the polymer. This may be done to prevent electrical breakdown around the edge of the polymer 202 or to achieve customized deflections for one or more portions of the polymer. As the term is used herein, an active area is defined as a portion of a transducer comprising the polymer material 202 and at least two electrodes. When the active area is used to convert electrical energy to mechanical energy, the active area includes a portion of the polymer 202 having sufficient electrostatic force to enable deflection of the portion. When the active area is used to convert mechanical energy to electrical energy, the active area includes a portion of the polymer 202 having sufficient deflection to enable a change in electrostatic energy. As will be described below, a polymer according to the present disclosure may have multiple active areas. In some cases, the polymer 202 material outside an active area may act as an external spring force on the active area during deflection. More specifically, polymer material outside the active area may resist active area deflection by its contraction or expansion. Removal of the voltage difference and the induced charge causes the reverse effects.

The electrodes 204, 206 are compliant and change shape with the polymer 202. The configuration of the polymer 202 and the electrodes 204, 206 provides for increasing the polymer 202 response with deflection. More specifically, as the transducer portion 200 deflects, compression of the polymer 202 brings the opposite charges of electrodes 204, 206 closer and the stretching of the polymer 202 separates similar charges in each electrode. In one embodiment, one of the electrodes 204, 206 is ground.

In general, the transducer portion 200 continues to deflect until mechanical forces balance the electrostatic forces driving the deflection. The mechanical forces include elastic restoring forces of the polymer 202 material, the compliance of electrodes 204, 206 and any external resistance provided by a device and/or load coupled to the transducer portion 200. The deflection of the transducer portion 200 as a result of the applied voltage may also depend on a number of other factors such as the polymer 202 dielectric constant and the size of polymer 202.

Electroactive polymers in accordance with the present disclosure are capable of deflection in any direction. After application of the voltage between electrodes 204, 206, the polymer 202 expands (stretches) in both of the planar directions 208, 210. In some cases, the polymer 202 is incompressible, e.g. has a substantially constant volume under stress. For an incompressible polymer 202, the polymer 202 decreases in thickness as a result of the expansion in the planar directions 208, 210. It should be noted the embodiments are not limited to incompressible polymers and deflection of the polymer 202 may not conform to such a simple relationship.

Application of a relatively large voltage difference between the electrodes 204, 206 on the transducer portion 200 shown in FIG. 2A will cause the transducer portion 200 to change to a thinner, larger area shape as shown in FIG. 2B. In this manner, the transducer portion 200 converts electrical energy to mechanical energy. The transducer portion 200 also may be used to convert mechanical energy to electrical energy in a bi-directional manner.

FIGS. 2A and 2B may be used to show one manner in which the transducer portion 200 converts mechanical energy to electrical energy. For example, if the transducer portion 200 is mechanically stretched by external forces to a thinner, larger area shape such as that shown in FIG. 2B, and a relatively small voltage difference (less than that necessary to actuate the film to the configuration in FIG. 2B) is applied between the electrodes 204, 206, the transducer portion 200 will contract in area between the electrodes to a shape such as in FIG. 2A when the external forces are removed. Stretching the transducer refers to deflecting the transducer 200 from its original resting position—typically to result in a larger net area for the portion of the polymer 200 between the electrodes, e.g., in the plane defined by the directions 208, 210 between the electrodes. The resting position refers to the position of the transducer portion 200 having no external electrical or mechanical input and may comprise any pre-strain in the polymer. Once the transducer portion 200 is stretched, the relatively small voltage difference is provided such that the resulting electrostatic forces are insufficient to balance the elastic restoring forces of the stretch. The transducer portion 200 therefore contracts, and it becomes thicker and has a smaller planar area in the plane defined by the directions 208, 210 (orthogonal to the thickness between electrodes in the direction 212). When the polymer 202 becomes thicker, it separates electrodes 204, 206 and their corresponding unlike charges, thus raising the electrical energy and voltage of the charge. Further, when the electrodes 204, 206 contract to a smaller area, like charges within each electrode compress, also raising the electrical energy and voltage of the charge. Thus, with different charges on the electrodes 204, 206, contraction from a shape such as that shown in FIG. 2B to one such as that shown in FIG. 2A raises the electrical energy of the charge. That is, mechanical deflection is being turned into electrical energy and the transducer portion 200 is acting as a generator.

In some cases, the transducer portion 200 may be described electrically as a variable capacitor. The capacitance decreases for the shape change going from that shown in FIG. 2B to that shown in FIG. 2A. Typically, the voltage difference between the electrodes 204, 206 will be raised by contraction. This is normally the case, for example, if additional charge is not added or subtracted from the electrodes 204, 206 during the contraction process. The increase in electrical energy, U, may be illustrated by the formula U=0.5 Q²/C, where Q is the amount of positive charge on the positive electrode and C is the variable capacitance which relates to the intrinsic dielectric properties of the polymer 202 and its geometry. If Q is fixed and C decreases, then the electrical energy U increases. The increase in electrical energy and voltage can be recovered or used in a suitable device or electronic circuit in electrical communication with the electrodes 204, 206. In addition, the transducer portion 200 may be mechanically coupled to a mechanical input that deflects the polymer and provides mechanical energy.

The transducer portion 200 will convert mechanical energy to electrical energy when it contracts. Some or all of the charge and energy can be removed when the transducer portion 200 is fully contracted in the plane defined by the directions 208, 210. Alternatively, some or all of the charge and energy can be removed during contraction. If the electric field pressure in the polymer 202 increases and reaches balance with the mechanical elastic restoring forces and external load during contraction, the contraction will stop before full contraction, and no further elastic mechanical energy will be converted to electrical energy. Removing some of the charge and stored electrical energy reduces the electrical field pressure, thereby allowing contraction to continue. Thus, removing some of the charge may further convert mechanical energy to electrical energy. The exact electrical behavior of the transducer portion 200 when operating as a generator depends on any electrical and mechanical loading as well as the intrinsic properties of the polymer 202 and electrodes 204, 206.

In one embodiment, the electroactive polymer 202 may be pre-strained. Pre-strain of a polymer may be described, in one or more directions, as the change in dimension in a direction after pre-straining relative to the dimension in that direction before pre-straining. The pre-strain may comprise elastic deformation of the polymer 202 and be formed, for example, by stretching the polymer in tension and fixing one or more of the edges while stretched. For many polymers, pre-strain improves conversion between electrical and mechanical energy. The improved mechanical response enables greater mechanical work for an electroactive polymer, e.g., larger deflections and actuation pressures. In one embodiment, pre-strain improves the dielectric strength of the polymer 202. In another embodiment, the pre-strain is elastic. After actuation, an elastically pre-strained polymer could, in principle, be unfixed and return to its original state. The pre-strain may be imposed at the boundaries using a rigid frame or may also be implemented locally for a portion of the polymer.

In one embodiment, pre-strain may be applied uniformly over a portion of the polymer 202 to produce an isotropic pre-strained polymer. By way of example, an acrylic elastomeric polymer may be stretched by 200 to 400 percent in both planar directions. In another embodiment, pre-strain is applied unequally in different directions for a portion of polymer 202 to produce an anisotropic pre-strained polymer. For example, a silicone film may be stretched by about 0 to 50% in one planar direction and about 30-100% in another planar direction. In this case, the polymer 202 may deflect greater in one direction than another when actuated. While not wishing to be bound by theory, the present inventors believe that pre-straining a polymer in one direction may increase the stiffness of the polymer in the pre-strain direction. Correspondingly, the polymer is relatively stiffer in the high pre-strain direction and more compliant in the low pre-strain direction and, upon actuation, more deflection occurs in the low pre-strain direction. In one embodiment, the deflection in the direction 208 of the transducer portion 200 can be enhanced by exploiting large pre-strain in the perpendicular direction 210. For example, an acrylic elastomeric polymer used as the transducer portion 200 may be stretched by 200 percent in the direction 208 and by 500 percent in the perpendicular direction 210. The quantity of pre-strain for a polymer may be based on the polymer material and the desired performance of the polymer in an application.

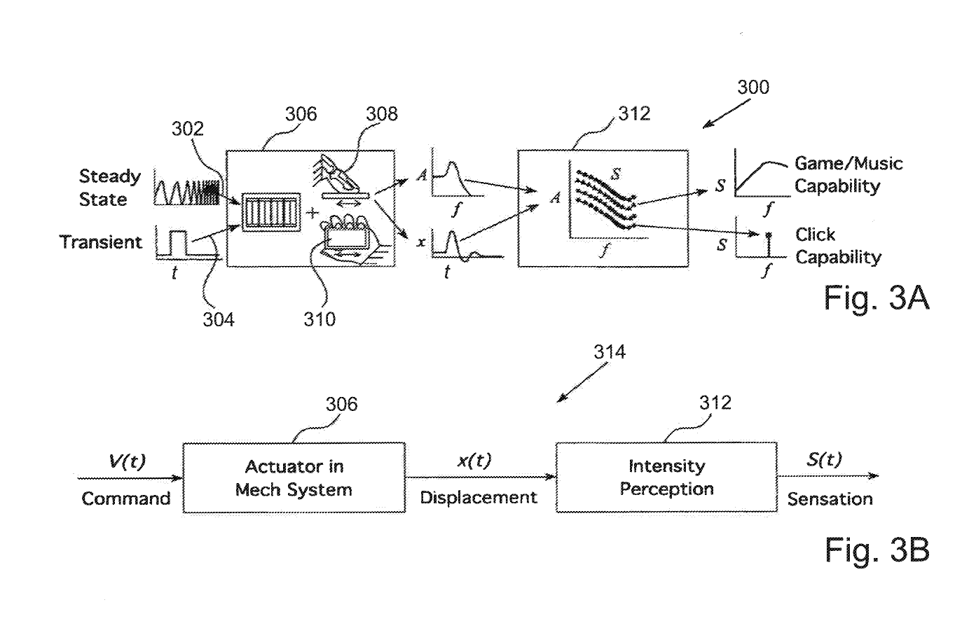

FIG. 3A is a diagram of a system 300 for quantifying the performance of an electroactive polymer module that provides suitable capability for gaming/music and click, according to one embodiment. The system 300 may be employed to generate electrical signals for electronic damping to improve “key click” replication on touchscreens commonly used for interfacing with computers and mechanical devices by a user. The system 300 also may be employed to create realistic tactile response when a user touches a surface, presses a button or key, or turns a knob. As shown in FIG. 3A, the output of the system 300 is sensation (S) versus frequency (t) in response to a steady state input 302 and a transient input 304 into an actuator mechanical system module 306 simulating the electroactive polymer module 100 of FIG. 1. Functionally, the actuator mechanical system module 306 represents a fingertip portion 308 applying an input pressure to the electroactive polymer module 100 or a palm portion 310 squeezing the haptic module 100. Applying maximum voltage to the actuator 100 at different frequencies produces steady state amplitudes A(f) in the actuator mechanical system module 306 that a user will perceive as sensations S(f). An intensity perception module 312 maps displacement to sensation. These sensations S(f) which depend on frequency and amplitude, have intensities that can be expressed in decibels, and describe the gaming capability of a design. The click capability can be described in a similar way. The amplitude of a transient response x(t) to a pulse at full voltage is mapped to sensation in decibels. That sensation is the most intense “click” the design can produce in a single cycle. Because gaming capability may leverage resonance, it can exceed click capability.

FIG. 3B is a functional block diagram 314 of the system 300, according to one embodiment. The sensation S(t) is produced in response to a steady state input command V(t). The actuator mechanical system module 306 produces a displacement x(t) in response to the input command V(t). The intensity perception module 312 maps the displacement input x(t) to sensation S(t).

In accordance with this approach, a model is constructed for quantifying capability of the electroactive polymer module 100. Also described is a calibration of the actuator mechanical system 306 in which the electroactive polymer module 100 works, which includes both the fingertip portion 308 and the palm portion 310. Sections of the present disclosure dealing with actuator performance provide a general-purpose model and an actuator segmenting method that tunes performance to match the actuator mechanical system 306. Calibration of the sensation model to published data is also presented. The capability of the haptic module 100 versus actuator geometry is discussed. Performance of real modules compared to the model and to measurements of other technologies also are discussed hereinbelow.

One application of interest for this model is a hand held mobile device, with an electroactive polymer module that drives a touchscreen laterally relative to the rest of the mobile device mass. A survey of a number of displays and touchscreens in different mobile devices resulted in a movable mass average of approximately 25 grams and a remaining device mass of approximately 100 grams. These values represent a significant population of mobile devices but could easily be altered for other classes of consumer electronics (i.e., global positioning satellite (GPS) systems, gaming systems).

### Accounting for the Mechanics of the Handset and User

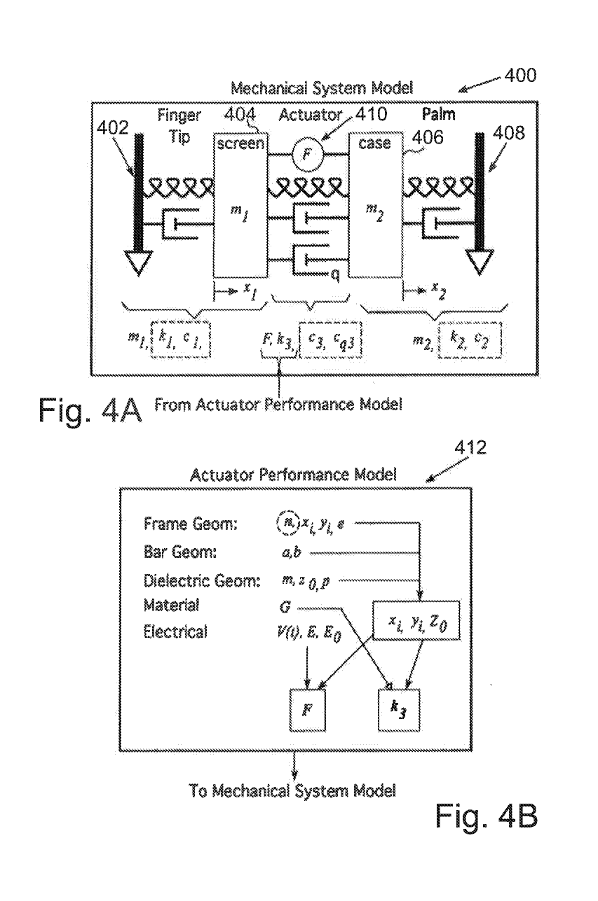

FIG. 4A is a mechanical system model 400 of the actuator mechanical system module 306 shown in FIGS. 3A-3B, according to one embodiment. The actuator mechanical system 306 shown in FIGS. 3A-3B is expanded. Dashed boxes indicate parameters of the fingertip 402, palm 408, and actuator 410 that were fit to data. In service, the electroactive polymer module 100 is part of a larger mechanical system that includes the fingertip 402, touchscreen 404, handset case 406, and palm 408. The mechanical system model 400 shows lumped elements that approximate this system and the actuator inside it. The fingertip 402 and palm 408 are treated as simple (m, k, c) mass-spring-damper systems. To estimate these parameters, the steady state response to proximal/distal shear vibration is measured at the index fingertip 402 during key press, and at the palm 408 holding a handset-sized mass. These measurements add data to the growing literature on haptic impedance, particularly tangential tractions on the skin where space constraints allow citation of only a few examples. Examples of such literatures include, for example, Lundstrom, R., “Local Vibrations—Mechanical Impedance of the Human Hand's Glabrous Skin,” Journal of Biomechanics 17, 137-144 (1984); Hajian, A. Z. and Howe, R. D., “Identification of the mechanical impedance at the human finger tip,” ASME Journal of Biomechanical Engineering 119(1), 109-114 (1997); and Israr, A., Choi, S. and Tan, H. Z., “Mechanical Impedance of the Hand Holding a Spherical Tool at Threshold and Suprathreshold Stimulation Levels,” Proceedings of the Second Joint EuroHaptics Conference and Symposium on Haptic Interfaces for Virtual Environment and Teleoperator Systems, 55-60 (2007).

FIG. 4B illustrates a performance model 412 of the actuator 410, according to one embodiment. Actuator force (F) and spring rate (k₃) depend on the geometry (first nine parameters), shear modulus (G), and electrical properties. A geometry variable, n (dashed circle), represents a variable that may be varied during simulation, for example. The actuator 410 can be treated as a force source in parallel with a spring and damper. Adding an additional damper, this one quadratic (F=−c_{q3}v²), may improve calibration to measured performance. The geometry of the actuator 410 determines the blocked force and passive spring rate. A Neo-Hookean model describes the mechanics of the dielectric subjected to pre-stretch (p) with one free parameter, shear modulus (G), that was calibrated to tensile stress/strain tests. An energy model yields a compact expression for force as function of actuator displacement and voltage. Segmenting the actuator into (n) sections allows designers to trade off the available mechanical work between long free stroke and high blocked force, and also to adjust the resonant frequency of the overall system to match the needs of the electroactive polymer modules.

### Segmentation Method

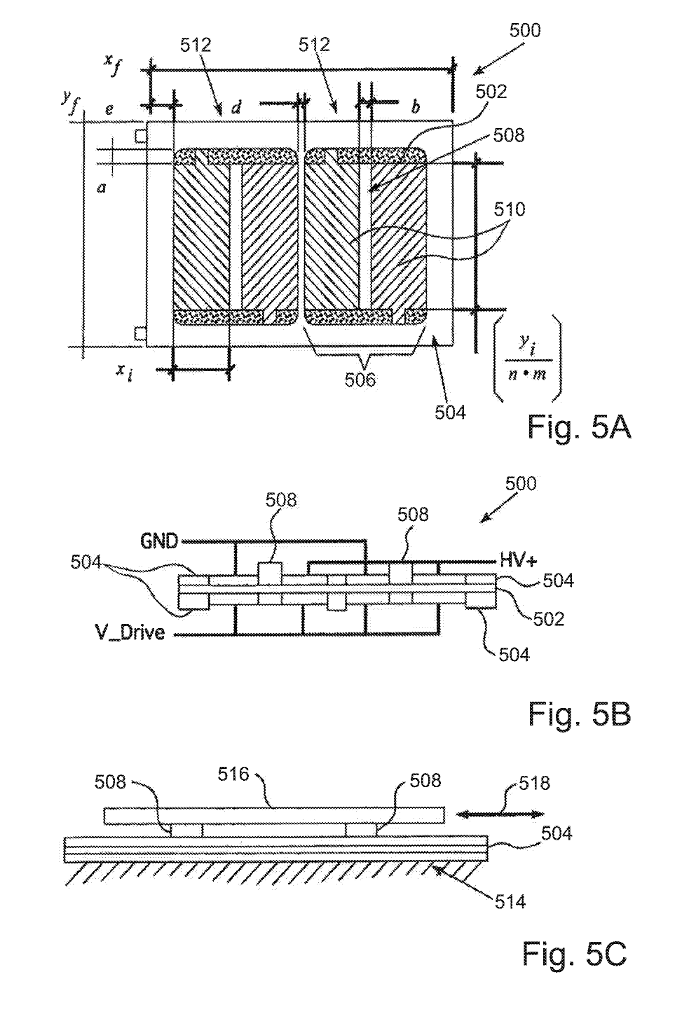

FIG. 5A illustrates one aspect of a segmented actuator 500 configured in a bar array geometry, according to one embodiment. Segmenting the actuator 500 within a given footprint into (n) sections provides a method for setting the passive stiffness and blocked force of the system. A pre-stretched dielectric elastomer 502 is held in place by a rigid material that defines an external frame 504 and one or more windows 506 within the frame 504. Inside each window 506 is a bar 508 of the same rigid frame material, and on one or both sides of the bar 508 are electrodes 510. Applying a potential difference across the dielectric elastomer 502 on one side of the bar 508 creates electrostatic pressure in the elastomer and this pressure exerts force on the bar 508, as described, for example, by Pelrine, R. E., Kornbluh, R. D. and Joseph, J. P., “Electrostriction Of Polymer Dielectrics With Compliant Electrodes As A Means Of Actuation,” Sensors and Actuators A 64, 77-85 (1998). The force on the bar 508 scales with the effective cross section of the actuator 500, and therefore increases linearly with the number of segments 512, each of which adds to the width (yᵢ). The passive spring rate scales with n₂, since each additional segment 512 effectively stiffens the actuator 500 device twice, first by shortening it in the stretching direction (xᵢ) and second by adding to the width (y) that resists displacement. Both spring rate and blocked force scale linearly with the number of dielectric layers (m).

FIG. 5B is a side view of the segmented actuator 500 shown in FIG. 5A that illustrates one aspect of an electrical arrangement of the phases with respect to the frame 504 and bars 508 elements of the actuator 500, according to one embodiment. FIG. 5C is a side view illustrating the mechanical coupling of the frame 504 to a backplane 514 and the bars 508 to an output plate 516. The output plate 516 of the segmented actuator 500 can be integrally incorporated with various devices, such as, for example, touchscreen displays, tablet computers, laptop computers, computer mice, trackballs, touch pad devices, remote control devices, user interfaces for appliances, gaming controllers, gaming consoles, portable gaming systems, computer displays, hand held devices, smartphones, mobile devices, mobile phones, mobile Internet devices, personal digital assistants, global positioning system receivers, remote controls, and the like, to provide feedback. In one embodiment, the output plate 516 or the segmented actuator 500 can be coupled to a moving mass to amplify the tactile feedback sensation to the user. In some embodiments, the moving mass may be a battery mounted in a tray.

With reference now to FIGS. 5A-C, segmenting the actuator 500 determines the effective rest length (xᵢ) of the composite segmented actuator 500 in the actuation direction 518, and the effective width (yᵢ) of the composite segmented actuator 500 according to:

$${x}_{i} = \frac{( {x}_{f} - ( 2 e + ( n - 1 ) d + nb ) )}{2 n} \\ and \\ {y}_{i} = n m ( {y}_{f} - 2 ( e + a ) ) \qquad ( 1 )$$

where:

x_{f} is the footprint in the x-direction;

y_{f} is the footprint in the y-direction;

d is the width of the dividers;

e is the width of the edges;

n is the number of segments;

b is the width of the bars;

a is the bar setback; and

m is the number of layers.

Simulation data in accordance with the present disclosure are based on d=1.5 mm dividers, b=2 mm bars, e=5 mm edges, x_{f}=76 mm x_footprint, and y_{f}=36 mm y_footprint. Other values related to the dielectric and geometry include, for example, shear modulus G, dielectric constant ∈, un-stretched thickness z₀, the number of layers m, and the bar setback a.

### Transient Response—Click Capability

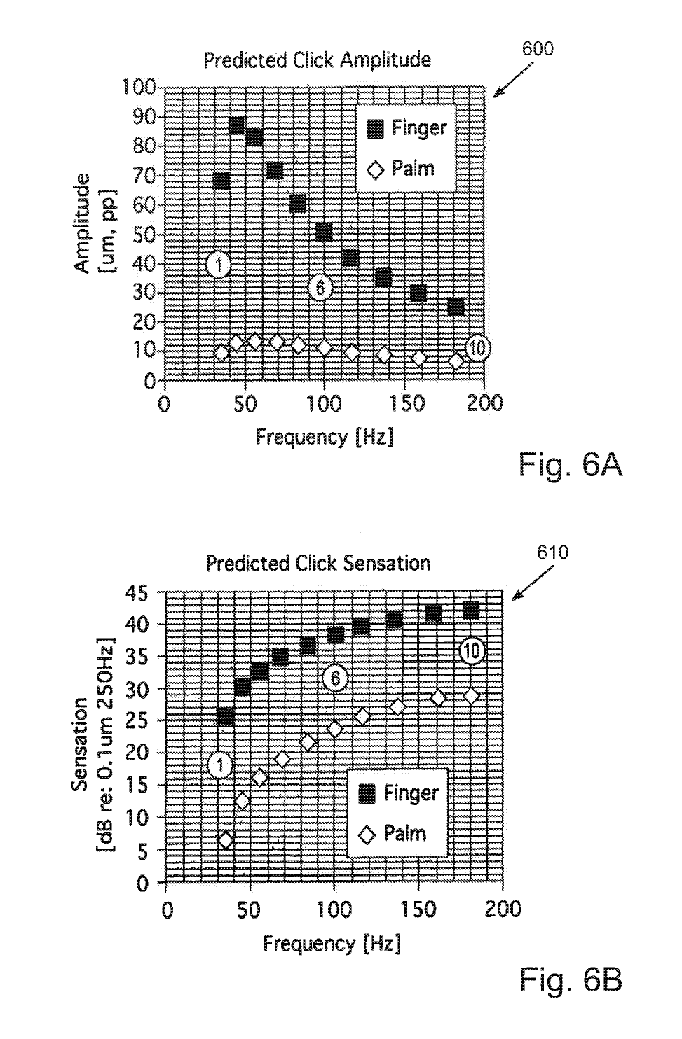

FIG. 6A is a graphical representation 600 of a predicted click amplitude that a candidate module could provide in service for the palm and fingertip, according to one embodiment. Amplitude in μm, pp is shown along the vertical axis and Frequency in Hertz (Hz) is shown along the horizontal axis. FIG. 6B is a graphical representation 610 of predicted click sensation that a candidate module could provide in service for the palm and fingertip, according to one embodiment. Sensation in dB re: 0.1 μm, 250 Hz is shown along the vertical axis and Frequency in Hertz (Hz) is shown along the horizontal axis. To evaluate the click capability offered by candidate designs, full voltage pulses are simulated. Duration of the pulse of one-quarter cycle of the resonant frequency can be varied depending on the design. Peak displacements can be converted into estimates of sensation level. Results are similar to those for steady state—more segments decreased amplitude, but increased sensation.

### Measured Module Performance Versus Modeled

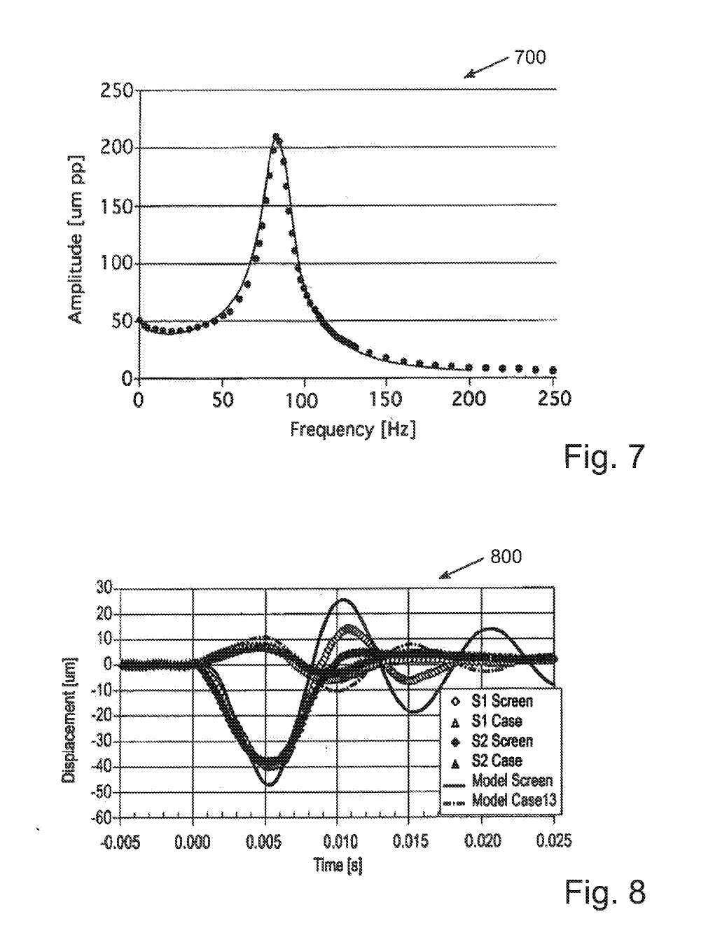

FIG. 7 is a graphical representation 700 of steady state response of the module with a test mass was measured on the bench top, modeled (line) versus measured (points), according to one embodiment. A six-segment actuator design provides a reasonable tradeoff between steady state gaming capability and click capability (FIG. 6). The steady state response of the six-segment actuator module with a test mass was measured on the bench (FIG. 7, points), and showed good agreement with the system model (FIG. 7, line). Amplitude on the bench exceeded simulation amplitude because bench testing eliminated stiffness, damping, and relative movement of the palm and fingertip.

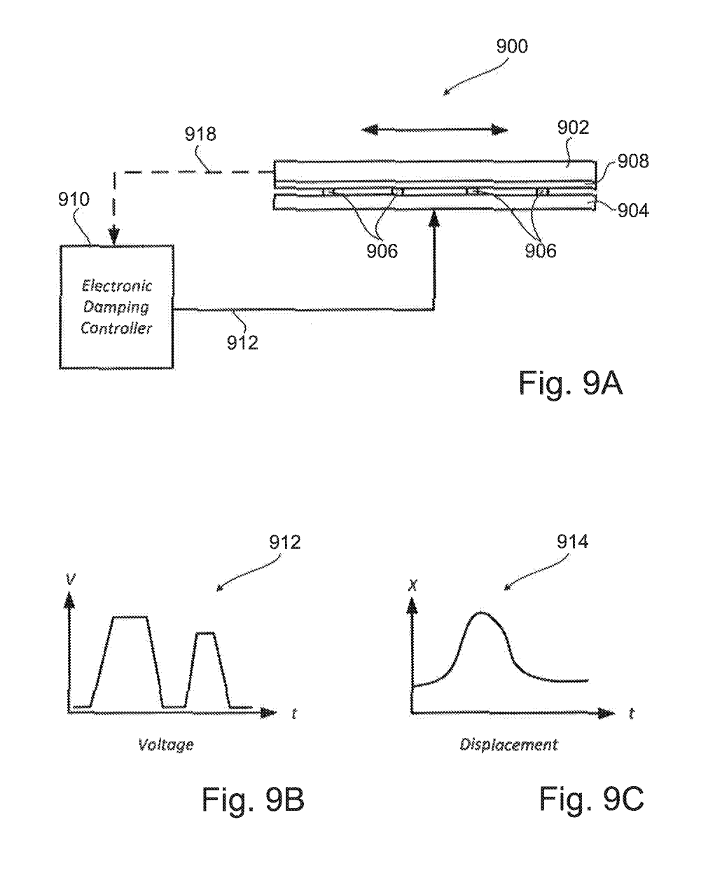

FIG. 8 is a graphical representation 800 of observed click data for two users (points), and predictions of the model for an average user (lines), according to one embodiment. Displacement in micrometers (μm) is shown along the vertical axis and Time in seconds (s) is shown along the horizontal axis. To assess the ability of the model to predict click capability of the module in service, two users tested a handset mockup. Each user held the “handset” (a ˜100 gram test mass) as they had during calibration. Mounted on the test mass was an electroactive polymer module, and mounted on the module was a second ˜25 gram mass, approximating the “screen.” The user touched the “screen” with a fingertip and ˜0.5 N press force, approximating a key press. A voltage pulse was applied to the module for 0.004 seconds, (approximately a quarter-cycle of the resonance of the modeled system). Displacement of the “phone” and “screen” (FIG. 8, points) were tracked with a laser displacement meter (Keyence, LK-G152). As shown (FIG. 8, lines) the model gave a reasonable estimate of the click transient these two users experienced as they touched the screen while supporting the phone case in the palm. It appears that these two grasps had lower spring rates and higher damping ratios than the model did as would be appreciated by those skilled in the art. The model was based on average values, and individual spring rates and damping coefficients varied substantially, even between grasps by the same subject.

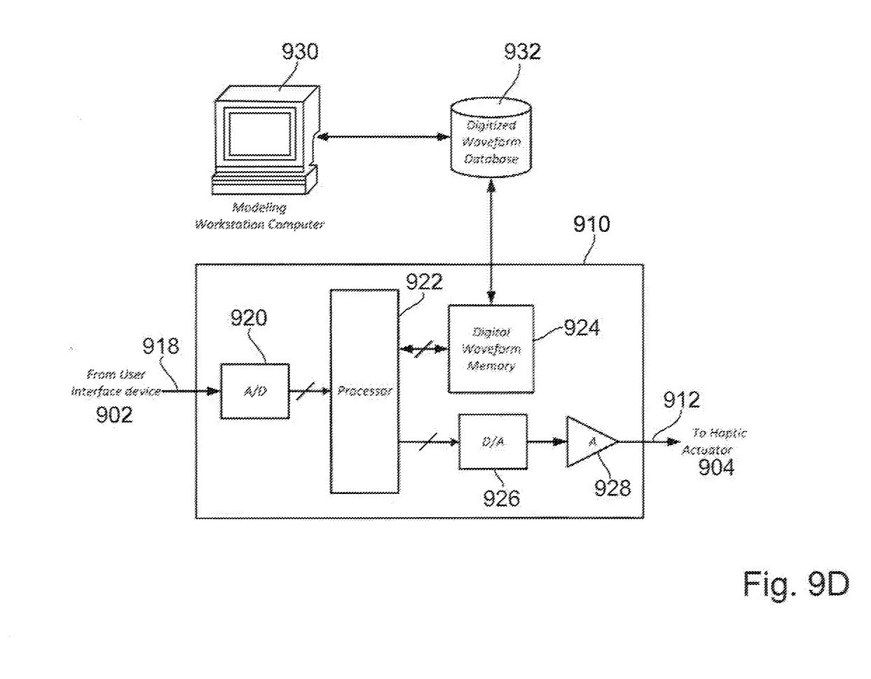

FIG. 9A illustrates an electronic damping feedback control system 900 comprising a segmented actuator 904 coupled to a user interface device 902 and an electronic damping controller 910, according to one embodiment. The segmented actuator 904 is similar to the segmented actuator 500 described in connection with FIG. 5A-5C. In one embodiment, the electronic damping feedback control system 900 comprises an electroactive polymer actuator 904 and an electronic damping controller 910 for generating electronic damping signals 912 to improve “key click” replication of the touchscreen interface device 902. In one embodiment, the actuator 904 (e.g., the segmented actuator) is coupled to a backplane 908 via actuator bars 906. The electronic damping controller 910 is coupled in a feedback loop between the user interface device 902 and the actuator 904. The backplane 908 is adapted and configured to couple to the user interface device 902 to provide tactile feedback to the user. The actuator 904 can be scaled to address any sized device, and can be incorporated into vertical displacement, horizontal displacement, and inertial drive configurations to accommodate a wide variety of applications, for example.

In various embodiments, the actuator 904 can be either direct drive or inertial drive or combinations thereof. A direct drive actuator 904 provides strong touch feedback in the preferred sensitivity spectrum (50-300 Hz) with rapid response times (5-10 ms). The direct drive actuator 904 can be configured to mount to the back of a display and/or touch sensor to provide direct feedback to the finger for touch devices or to mount to a battery tray to provide inertial feedback that can be felt in the entire device. The direct drive actuator 904 enhances the user experience of user interface devices 902 by synchronizing feedback with the sight and sound in applications. The direct drive actuator 904 enables various combinations of sensations due to the rapid response time and wide frequency operating range. The direct drive actuator 904 may be driven with low input voltage in the range of 0-3.7V and can be controlled by triggering, pulse width modulation (PWM), or analog voltage.

An inertial drive actuator 904 provides strong touch feedback in the preferred sensitivity spectrum (50-300 Hz) with rapid response times (5-10 ms). The inertial drive actuator 904 enhances the user experience of mobile devices by synchronizing feedback with the sight and sound in applications. The inertial drive actuator 904 enables various combinations of sensations due to the rapid response time and wide frequency operating range. The inertial drive actuator 904 may be driven with low input voltage in the range of 0-3.7V and can be controlled by triggering, pulse width modulation, or analog voltage.

In some embodiments, there may be multiple actuators 904 which may be driven with common or independent drive circuits and/or electronic damping feedback control systems 900. This may be advantageous in user interface devices where both short (e.g. “key clicks”) and long (e.g. gaming/music) responses are desired. It may also be advantageous to distribute the feedback response both spatially and temporally in some applications. For example, “key clicks” can be delivered in a portion of the device designed to act as a keypad while gaming responses can be delivered to the portion of the device held in the palm of the hand. Another example is in a headphone where directional, quantitative, and qualitative information may be conveyed to the user by independent control of the effects through each ear cup, e.g. short effects may be delivered to one ear cup of the headphone while long effects are delivered independently to the second ear cup of the headphone.

The electronic damping feedback control system 900 is configured to produce tactile feedback to the user by moving the user interface device 902. In various embodiments, the user interface device 902 may be a touchscreen display of a tablet computer, laptop computer, computer display, smartphone, mobile device, mobile phone, mobile Internet device, personal digital assistant, global positioning system receiver, desktop phones, casino gaming machines, point-of-sale kiosks, industrial controls. In other embodiments, the interface device 902 may be an input device such as computer mouse, trackball, touch pad, remote control device, user interface for appliances, gaming controller, gaming console, portable gaming system, remote control, and the like. The movement of the user interface device 902 may be in plane or out of plane. For electroactive polymer systems designed for resonant operation (typically 70 Hz-150 Hz), a single actuator impulse provides a tactile response to the user. This response typically includes late time mechanical ringing that generates an undesirable and unrealistic effect. This undesirable mechanical ringing effect can be minimized or substantially eliminated by applying a counteracting complex waveform to the actuator 904 to provide electronic damping and produce a realistic “key click” effect.

In one embodiment, the electronic damping functionality can be implemented by an electronic damping controller 910 that is coupled to the circuits of the user interface device 902. The electronic damping controller 910 makes it possible to control the damping force of the user interface device 902 by applying a damping voltage control signal 912 applied to the actuator 904 and dampen mechanical movements, such as vibrations. In one embodiment, the electronic damping controller 910 is configured to detect an actuation signal 918 generated by the user interface device 902 when the user touches the user interface device. In response to the actuation signal 918, the electronic damping controller 910 applies a damping voltage control signal 912 (FIG. 9B, according to one embodiment) to the actuator 904 to control the damping of the user interface device 902. The voltage signal 902 dampens the motion of the actuator 904 and hence the motion 916 of the user interface device 902 to reduce or substantially minimize the unwanted mechanical ringing and provide a realistic “key click” tactile feedback to the user. The damping voltage control signal 912 applied to the actuator 904 causes the actuator 904 to move in accordance with the displacement curve 914 shown in FIG. 9C, according to one embodiment.

The damping voltage control signal 912 characteristics such as waveform shape, amplitude, and frequency, for example, required to dampen a particular mechanical ringing of a user interface device 902 response can be determined empirically or can be modeled. The system 300 (FIGS. 3A, 3B) for quantifying the performance of electroactive polymer modules may be employed to determine the damping voltage control signal 912 characteristics, for example. Furthermore, the damping voltage control signal 912 characteristics can be modeled using the mechanical system model 400 described in connection with FIG. 4A and the actuator performance model 412 described in connection with FIG. 4B. The characteristics of the damping voltage control signal 912 may be determined based on graphical representations of predicted click amplitude that a candidate module could provide in service for the palm and fingertip as shown in FIG. 6A or based on graphical representations of predicted click sensations that a candidate module could provide in service for the palm and fingertip, for example. Other useful data for determining the characteristics of the damping voltage control signal 912 include, without limitation, steady state response of a module with a test mass, observed click data for users, and predictions of the model for an average user as described in connection with FIGS. 7 and 8. It will be appreciated that other techniques may be employed to determine the characteristics of the damping voltage control signal 912. Accordingly, once the mechanical ringing pattern of a particular user interface device 902 is determined, the characteristics of the damping voltage control signal 912 can be developed such that application of the damping voltage control signal 912 to the actuator 902 electronically controls the damping of the module 904.

In various embodiments, the electronic damping controller 910 includes a memory for storing a plurality of electronic voltage damping signals that can be applied based on the actuation signal and/or the specific pattern of vibrational ringing produced by a particular user interface device 902 when providing haptic feedback. Furthermore, the damping voltage control signal 912 waveform can be modified by elements of the electronic damping controller 910 in order to accommodate the strength and/or waveform type of the detected actuation signal 918 from the user interface device 902. Accordingly, once the damping voltage control signal 912 is selected by the electronic damping controller 910, the damping voltage control signal 912 may be amplified or dampened in accordance with the detected actuation signal 918. The electronic damping controller 910 may be digital, analog, or a combination thereof. In a digital signal processing implementation, the required electronic damping voltage signal profiles may be stored in a digital format and a digital-to-analog converter and/or an amplifier can be used to generate the damping voltage control signal 912 to apply to the actuator. In other embodiments, the electronic damping controller comprises a microprocessor, a memory, an analog-to-digital converter, a digital-to-analog converter, and amplifiers.

FIG. 9D illustrates an electronic damping controller 910, according to one embodiment. In one embodiment, the electronic damping controller 910 receives a signal from the user interface device 902 and outputs a corresponding electronic damping signal 912 to the electroactive polymer actuator 904 to improve “key click” replication of the touchscreen interface device 902. The actuation signal 918 received from the user interface device 902 may be a simple pulse or may be a digital value that represents how much force was used to actuate the user interface device 902. An analog-to-digital (A/D) converter 920 digitizes the actuation signal 918 and provides it to a processor 922. In various embodiments, the processor 922 may be a general purpose processor, a Digital Signal Processor (DSP), an Application Specific Integrated Circuit (ASIC), a Field Programmable Gate Array (FPGA), Programmable Logic Device (PLD) or other programmable logic device, discrete gate or transistor logic, discrete hardware components, or any combination thereof designed to perform the functions described herein. Based on preprogrammed logic or based on real time evaluation of the actuation signal 918, the processor 922 selects an appropriate digital waveform from memory 924. The digital waveforms 924 may be stored in the memory 924 and are correlated to various user interface devices 902. Accordingly, when the processor 922 receives the actuation signal 918 it can select the appropriate digital waveform from the memory 924. A digital-to-analog (D/A) converter 926 converts the digitized waveform information into an analog signal which is amplified by an amplifier 928. The amplifier 928 is coupled to the electroactive polymer actuator 904 and applies the selected electronic damping signal 912 in analog form to the electroactive polymer actuator 904. In one embodiment, the processor 922 may be configured to generate a suitable electronic damping signal 912 based solely on the characteristics of the actuation signal 918 without the need for storing the waveform in memory 924. In other embodiments, the actuation signal 918 may include actuation force information such that the processor 922 can apply a scaling factor to the digitized waveform prior to the digital-to-analog converter 926. It will be appreciated that a programmable gain amplifier can accomplish the same scaling function, without limiting the scope of the present disclosure.

In one embodiment, a modeling workstation computer 930 can be used to generate electronic damping signal 912 waveforms, which are then stored in a digitized waveform database 932. The database 932 can be coupled to the electronic damping controller 910 such that the digital waveform memory 924 may be periodically updated with the contents of the database 932.

In one embodiment, the electronic damping signal 912 may be optimized by the user based on the type of user interface device 902. In regards thereto, the electronic damping controller 910 can be placed in “learn” mode where the user applies a force to the user interface device 902 and feels for the “key click” tactile feedback. The electronic damping controller 910 then displays a graphical indication on the user interface device 902 to enable the user to adjust the amplitude, frequency, or other characteristics of the electronic damping signal 912. Thus, by trial and error, the user can optimize the “key click” tactile feedback. The adjustment process may be simplified, by enabling the user to enter suitable damping coefficients which the electronic damping controller 910 converts to a suitable electronic damping signal 912.

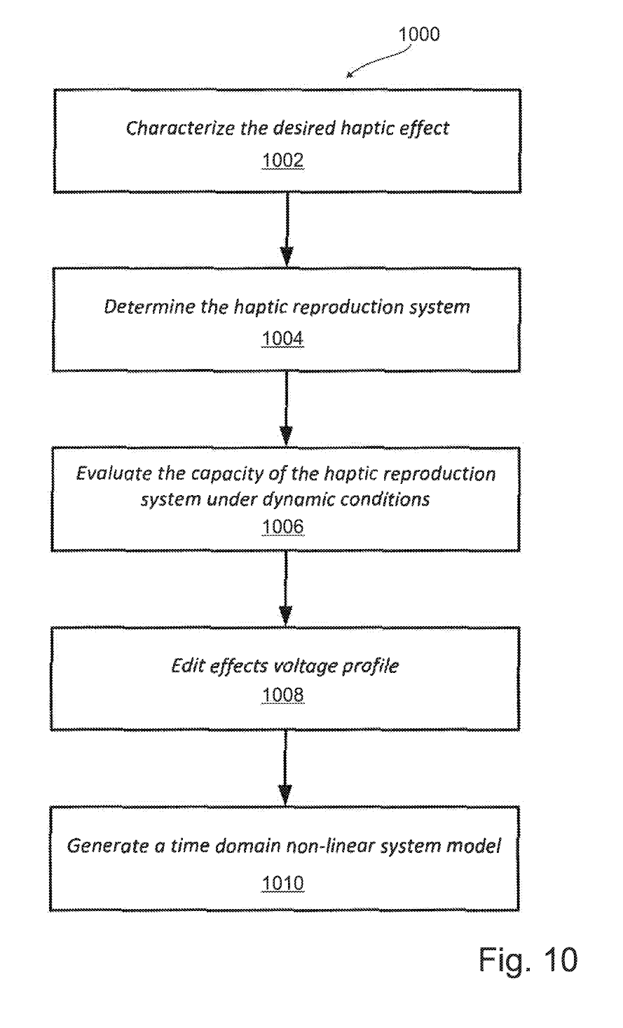

FIG. 10 is a logic diagram of a computer-implemented method 1000 for creating realistic effects, according to one embodiment. In accordance with one embodiment, at 1002, the method 1000 comprises characterizing the desired effect. The characterization of the desired effect includes measuring the acceleration, velocity, and displacement of an electroactive polymer system in the time domain and determining whether the electroactive polymer system follows a linear, second order, mass-spring damper system or whether it is also a dual resonant coupled system such as direct or inertial actuator systems. The system is characterized with regards to resonant frequency, mass, stiffness, and damping. Any audio effects are also characterized.

At 1004, in one embodiment, the method 1000 comprises determining an electroactive polymer reproduction system for the desired effect. This includes selecting an actuator for the electroactive polymer system, direct or inertial drive, the moving mass (or suspended and reaction mass), blocked force capacity, stroke. This process further includes estimating a typical load for direct drive and inertial drive systems. In other words, estimating whether it is a finger touch or held in hand, etc.

At 1006, in one embodiment, the method 1000 comprises evaluating a capacity of the electroactive polymer reproduction system under dynamic conditions. This process further comprises, determining whether an actuator drive waveform corresponding to the desired effect will be in the linear or non-linear mode of operation. This process further comprises, determining whether axis translation is in effect (normal to tangential).

At 1008, in one embodiment, the method 1000 comprises editing an effects voltage profile until the desired effect output is obtained for relatively simple effects or effects that are substantially similar to past results. Although this process may be characterized as trial-and-error, the method works well when previous waveforms are fairly close to the desired response.

At 1010, in one embodiment, the method 1000 comprises generating a time domain, non-linear system model for complex or non-linear effects. The process further comprises deriving the necessary input waveform to produce the desired effect using closed loop feedback analysis. When a realizable solution is obtained, the process comprises implementing the realizable solution and repeating the editing process described in 1008 for fine tuning. When a realizable solution is not obtained, the process comprises changing the reproduction system.

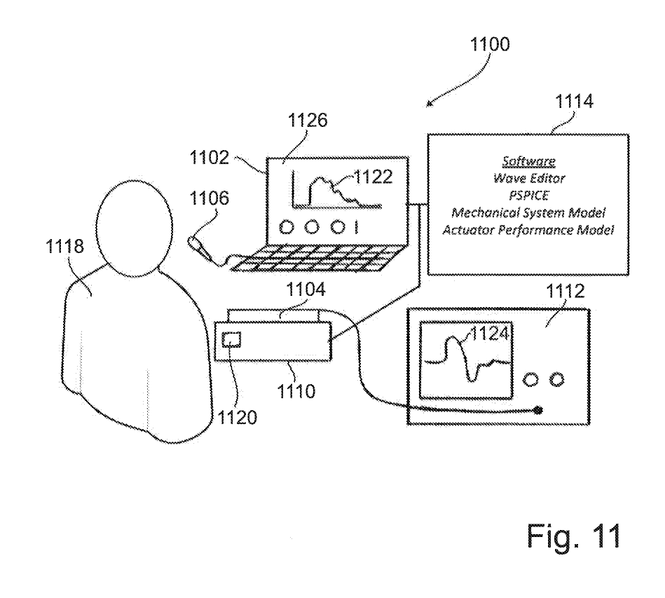

FIG. 11 illustrates a system 1100 in which embodiments of the method 1000 described in connection with FIG. 10 may be implemented. In various embodiments, the method 1000 may be implemented in a combination of hardware and software. The hardware may comprise, for example, a general purpose computer 1102, an accelerometer 1104, a microphone 1106, trigger controller 1110, and a waveform display device 1112. The software 1114 may comprise, for example, a wave editor and PSPICE modeling program. The system output includes a mechanical system model 400 and actuator performance model 412 as described in connection with FIGS. 4A, 4B and the system for quantifying the performance of an electroactive polymer module that provides suitable capability for gaming/music and click applications as described in connection with FIGS. 3A, 3B, for example, all of which can be executed by the general purpose computer 1102. The method 1000 further comprises simultaneously recording and playing back both audio and haptic effects until the designer 1118 is satisfied with the desired effect. The playback is triggered by physically pressing a sensor 1120, which is part of the perception process. Closed-loop control of a system model (e.g., in PSPICE) creates a voltage waveform 1122 that gives the desired acceleration and is displayed by the computer display 1126. During fine tuning of the voltage waveform 1122, acceleration is measured and the waveform 1124 is displayed on the waveform display device 1112.

After creating the mechanical system model 400 and the actuator performance model 412, as described in connection with FIGS. 4A, 4B, using the method 1000, the general purpose computer 1102 is configured to execute the mechanical system model 400 and the actuator performance model 412 to develop desired effects. As previously discussed, the mechanical system model 400 is used to model the mechanical aspects of the desired electroactive polymer actuator. The dashed boxes indicate parameters of the fingertip 402, palm 408, and actuator 410 that are fit to data to generate the model. The fingertip 402 and palm 408 are treated as simple (m, k, c) mass-spring-damper systems. To estimate these parameters, the steady state response to proximal/distal shear vibration is measured at the index fingertip 402 during key press, and at the palm 408 holding a handset-sized mass. Actuator force (F) and spring rate (k₃) depend on the geometry (first nine parameters), shear modulus (G), and electrical properties. A geometry variable, n (dashed circle), represents a variable that is varied during the simulation, for example. The actuator 410 can be treated as a force source in parallel with a spring and damper.

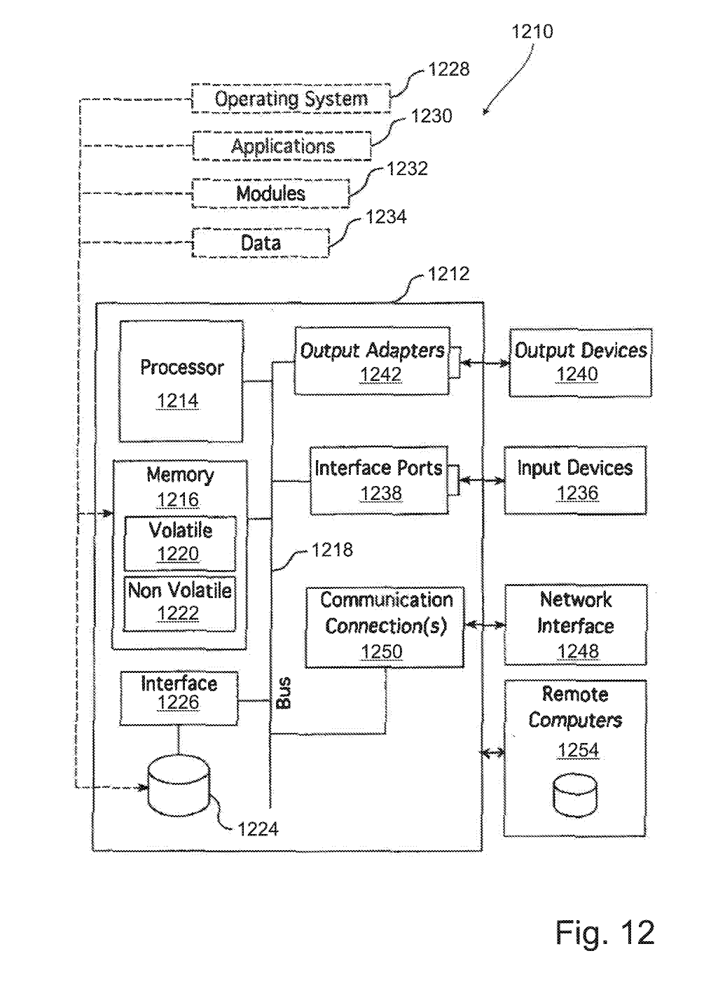

Having described the computer-implemented method 1000 and a system 1100 for creating realistic effects in general terms, the disclosure now turns to one non-limiting example of a general purpose computer 1102 environment in which the method 1000 may be implemented. FIG. 12 illustrates an example environment 1210 that is representative of the general purpose computer 1102 for implementing various aspects of the computer-implemented method 1000 for quantifying the capability of an electroactive polymer apparatus, according to one embodiment. A computer system 1212 includes a processor 1214, a system memory 1216, and a system bus 1218. The system bus 1218 couples system components including, but not limited to, the system memory 1216 to the processor 1214. The processor 1214 can be any of various available processors. Dual microprocessors and other multiprocessor architectures also can be employed as the processor 1214.

The system bus 1218 can be any of several types of bus structure(s) including the memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), Small Computer Systems Interface (SCSI) or other proprietary bus.

The system memory 1216 includes volatile memory 1220 and nonvolatile memory 1222. The basic input/output system (BIOS), containing the basic routines to transfer information between elements within the computer system 1212, such as during start-up, is stored in nonvolatile memory 1222. For example, the nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. Moreover, RAM is available in many forms such as synchronous RAM (SRAM) dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The computer system 1212 also includes removable/non-removable, volatile/non-volatile computer storage media. FIG. 12 illustrates, for example a disk storage 1224. The disk storage 1224 includes, but is not limited to, devices like a magnetic disk drive, floppy disk drive, tape drive, JAZ drive, Zip drive, LS-60 drive, flash memory card, or memory stick. In addition, the disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface 1226 is typically used.

It is to be appreciated that FIG. 12 describes software that acts as an intermediary between users and the basic computer resources described in a suitable operating environment 1210. Such software includes an operating system 1228. The operating system 1228, which can be stored on the disk storage 1224, acts to control and allocate resources of the computer system 1212. System applications 1230 take advantage of the management of resources by the operating system 1228 through program modules 1232 and program data 1234 stored either in the system memory 1216 or on the disk storage 1224. It is to be appreciated that various components described herein can be implemented with various operating systems or combinations of operating systems.

A user enters commands or information into the computer system 1212 through input device(s) 1236. The input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processor 1214 through the system bus 1018 via interface port(s) 1238. The interface port(s) 1238 include, for example, a serial port, a parallel port, a game port, and a universal serial bus (USB). The output device(s) 1240 use some of the same type of ports as input device(s) 1236. Thus, for example, a USB port may be used to provide input to the computer system 1212 and to output information from the computer system 1212 to an output device 1240. An output adapter 1242 is provided to illustrate that there are some output devices 1240 like monitors, speakers, and printers, among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

The computer system 1212 can operate in a networked environment using logical connections to one or more remote computers, such as the remote computer(s) 1244. The remote computer(s) 1244 can be a personal computer, a server, a router, a network PC, a workstation, a microprocessor based appliance, a peer device or other common network node and the like, and typically includes many or all of the elements described relative to the computer system 1212. For purposes of brevity, only a memory storage device 1246 is illustrated with the remote computer(s) 1244. The remote computer(s) 1244 is logically connected to the computer system 1212 through a network interface 1248 and then physically connected via a communication connection 1250. The network interface 1248 encompasses communication networks such as local-area networks (LAN) and wide area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

The communication connection(s) 1250 refers to the hardware/software employed to connect the network interface 1248 to the bus 1218. Although the communication connection 1250 is shown for illustrative clarity inside the computer system 1212, it can also be external to the computer system 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

As used herein, the terms “component,” “system” and the like can also refer to a computer-related entity, either hardware, a combination of hardware and software, software, or software in execution, in addition to electro-mechanical devices. For example, a component may be, but is not limited to being, a process running on a processor, a processor, an object, an executable, a thread of execution, a program, and/or a computer.

It is worthy to note that any reference to “one aspect” or “an aspect” means that a particular feature, structure, or characteristic described in connection with the aspect is included in at least one aspect. The appearances of the phrase “in one aspect” or “in one aspect” in the specification are not necessarily all referring to the same aspect.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that any reference to “one embodiment” or “an embodiment” means that a particular feature, structure, or characteristic described in connection with the embodiment is included in at least one embodiment. The appearances of the phrase “in one embodiment” or “in one aspect” in the specification are not necessarily all referring to the same embodiment.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It will be appreciated that those skilled in the art will be able to devise various arrangements which, although not explicitly described or shown herein, embody the principles of the present disclosure and are included within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, embodiments, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary embodiments and embodiments shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the invention and does not pose a limitation on the scope of the invention otherwise claimed. No language in the specification should be construed as indicating any non-claimed element essential to the practice of the invention. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments and appended claims.

What is claimed is:

1. An electronic damping feedback control system for an electroactive polymer module, the system comprising:
an electronic damping controller coupled in a feedback loop between a user interface device and an electroactive polymer actuator, wherein the actuator is coupled to the user interface device, and wherein the electronic damping controller is configured to receive an actuation signal from the user interface device in response to a user input and, in response to the actuation signal, the electronic damping controller is to generate an electronic damping signal to drive the actuator and dampen mechanical movement.

2. The feedback control system according to claim 1, wherein the electronic damping controller comprises a memory for storing digital waveforms correlated to an electronic damping signal, and wherein the electronic damping controller is to select a waveform from the memory that corresponds to a predetermined type of user interface device and/or actuation signal.

3. The feedback control system according to claim 2, further comprising a processor to determine the type of user interface device based on characteristics of the actuation signal and to select a waveform from the memory that corresponds to a predetermined type of user interface device and/or actuation signal.

4. The feedback control system according to claim 3, further comprising:
a digital-to-analog converter coupled to the processor, wherein the converter generates an analog signal representation of the waveform selected from the memory; and
an amplifier coupled to the converter to amplify the analog signal received from the converter.

5. The feedback control system according to claim 4, wherein the processor is configured to apply a scaling factor to the waveform selected from the memory to scale the electronic damping signal in accordance with a force indicated by the actuation signal.

6. The feedback control system according to one of claims 4 and 5, wherein the amplifier is a programmable gain amplifier and is configured to apply a scaling factor to the waveform selected from the memory to scale the electronic damping signal in accordance with a force indicated by the actuation signal.

7. The feedback control system according to any one of claims 1 to 6, wherein the electronic damping signal is configured to drive one selected from the group consisting of an inertial drive actuator and a direct drive actuator.

8. The feedback control system according to any one of claims 1 to 7, wherein the electronic damping controller is configured to receive input from the user to optimize the electronic damping signal in accordance with a user preference.

9. A device comprising:
a user interface device;
an electroactive polymer actuator coupled to the user interface device; and
the electronic damping feedback control system according to any one of claims 1 to 8.

10. The device according to claim 9, wherein the electronic damping signal is designed using a computer-implemented method for creating realistic effects, the method comprising:
characterizing a desired effect of an electroactive polymer system;
determining a reproduction system for the desired effect;
evaluating a capacity of the reproduction system under dynamic conditions;
editing an effects voltage profile until the desired effect output is obtained; and
generating a time domain non-linear system model in accordance with the desired effect.

11. The device according to claim 10, wherein characterizing the desired effect comprises:
measuring acceleration, velocity, and displacement of the system in the time domain; and
determining whether the electroactive polymer system follows a linear, second order, mass-spring damper system or whether the electroactive polymer system follows a dual resonant coupled system, wherein the electroactive polymer system is characterized with regards to resonant frequency, mass, stiffness, and damping.

12. The device according to one of claims 10 and 11, wherein determining a reproduction system for the desired effect, further comprises:
selecting an electroactive polymer actuator for the electroactive polymer system; and
estimating a load for the selected electroactive polymer actuator.

13. The device according to any one of claims 10 to 12, wherein evaluating a capacity of the electroactive polymer reproduction system under dynamic conditions further comprises:
determining whether an electroactive polymer actuator drive waveform corresponding to the desired effect is linear or non-linear.

14. The device according to any one of claims 10 to 13, further comprising editing the effects voltage profile until the desired effect output is obtained for simple effects or for effects that are substantially similar to past results.

15. The device according to any one of claims 10 to 14, wherein generating a time domain non-linear system model in accordance with the desired effect, further comprises:
deriving an input waveform to produce the desired effect using closed loop feedback analysis.

16. The device according to any one of claims 10 to 15, wherein generating a time domain non-linear system model in accordance with the desired effect, further comprises:
repeating editing the effects voltage profile until the desired effect output is obtained.

17. The device according to any one of claims 9 to 16, wherein the device is selected from the group consisting of a touchscreen display, a tablet computer, a laptop computer, a computer mouse, a trackball, a touch pad device, a remote control device, a user interface for an appliance, a gaming controller, a gaming console, a portable gaming system, a computer display, a hand held device, a smartphone, a mobile device, a mobile phone, a mobile Internet device, a personal digital assistant, a global positioning system receiver, a remote control, a computer peripheral and a gaming peripheral.
